(19) United States
(12) Patent Application Publication
(10) Pub. No.: US 2025/0380331 A1
(43) Pub. Date: Dec. 11, 2025

(54) TECHNOLOGIES FOR SEMI-STATIC, AUTOMATED, PAIRED CONFIGURATION OF DISCONTINUOUS RECEPTION

(71) Applicant: Apple Inc., Cupertino, CA (US)

(72) Inventors: Aimin J. Sang, Santa Clara, CA (US); Xipeng Zhu, San Diego, CA (US); Ehsan Haghani, Redwood City, CA (US); Erdogan Dede, San Diego, CA (US); Sharad Sambhwani, San Diego, CA (US)

(73) Assignee: Apple Inc., Cupertino, CA (US)

(21) Appl. No.: 19/075,646

(22) Filed: Mar. 10, 2025

Related U.S. Application Data
(60) Provisional application No. 63/658,727, filed on Jun. 11, 2024.

(51) Int. Cl. H04W 76/28; H04B 7/06; H04L 41/16; H04L 41/5067

(52) U.S. Cl. CPC H04W 76/28; H04B 7/0626; H04L 41/16; H04L 41/5067

(57) ABSTRACT

The present application relates to devices and components, including apparatus, systems, and methods for connected mode discontinuous reception (C-DRX).

### CROSS-REFERENCES TO OTHER APPLICATIONS

This application claims priority to U.S. Provisional Application No. 63/658,727, for “TECHNOLOGIES FOR SEMI-STATIC, AUTOMATED, PAIRED CONFIGURATION OF DISCONTINUOUS RECEPTION” filed on Jun. 11, 2024, which are herein incorporated by reference in their entirety for all purposes.

### TECHNICAL FIELD

This application generally relates to communication networks, particularly connected mode discontinuous reception (C-DRX).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a timing diagram in accordance with some embodiments.

FIG. 3 illustrates a signaling diagram in accordance with some embodiments.

FIG. 4 illustrates an operation diagram in accordance with some embodiments.

FIG. 5 illustrates a dataset pipeline in accordance with some embodiments.

FIG. 6 illustrates another signaling diagram in accordance with some embodiments.

FIG. 7 illustrates another operation diagram in accordance with some embodiments.

FIG. 8 illustrates another signaling diagram in accordance with some embodiments.

FIG. 9 illustrates another signaling diagram in accordance with some embodiments.

FIG. 10 illustrates an operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates another operation flow/algorithmic structure in accordance with some embodiments.

FIG. 14 illustrates a user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

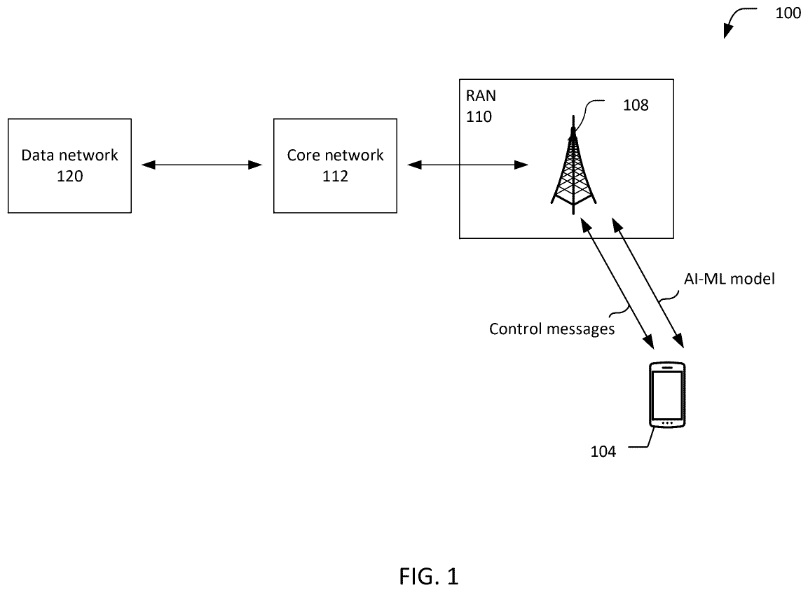

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The network environment 100 may further include a core network 112. For example, the core network 112 may comprise a 5th Generation Core network (5GC) or a later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The network environment 100 may further include a data network 120. Data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Base station 108 may configure UE 104 with discontinuous reception (DRX). DRX is a power-saving technique employed to increase the battery life of UE 104. With DRX, UE 104 may periodically switch off its receiver and enter a low-power state when there is no data to receive, thereby conserving energy. DRX configuration may include parameters such as the on-duration timer, inactivity timer, and DRX cycle length, which dictate when the UE should perform a wake up procedure to check for incoming data. This mechanism is particularly beneficial for prolonging the battery life of devices such as smartphones, wearable devices, and Internet of Things (IoT) devices, which often need to operate on limited power sources for extended periods.

Connected mode DRX (C-DRX) is a specific implementation of DRX. While DRX generally pertains to radio resource control (RRC) idle mode, C-DRX is designed for scenarios where the UE 104 is in an active data session, e.g., RRC connected mode, but still requires power-saving mechanisms. In C-DRX, the UE 104 alternates between periods of active reception and low-power state even while maintaining an active connection with the network. This is achieved by coordinating the DRX cycles with the network's scheduling decisions, allowing the UE 104 to manage its power consumption without compromising the quality of service (QoS). In some embodiments, C-DRX configurations are dynamically adjusted based on the UE's activity level and network conditions, providing a more granular control over power saving and latency management.

The configuration and optimization of DRX parameters are crucial for balancing the trade-off between energy efficiency and latency, ensuring that the UE 104 may promptly respond to network signaling and data transmission requirements. In some instances, the network (e.g., base station 108 or core network 112) may control and configure C-DRX parameters. The C-DRX configuration may include several parameters, each with several possible values, creating a large number of C-DRX possible configurations based on different combinations of values for each parameter. The large number of C-DRX possible configurations makes determining the values of all the parameters to achieve a trade-off between power saving and performance complex.

In some instances, network operators may create one or more C-DRX profiles. A C-DRX profile may refer to a predefined set of parameters and settings that dictate how the C-DRX mechanism may operate under specific conditions. These profiles may be designed to optimize the UE's power consumption and network performance based on various factors, such as the type of application being used, network conditions, or user preferences. Different profiles may be configured or activated by the base station 108 based on the context, such as streaming video, browsing the Internet, or being in a low-coverage area. In some instances, the profile may be selected by the base station 108 or manually by the user of the UE 104. The C-DRX profiles may be designed based on the quality of experience (QoE) or QoS parameters of an application (e.g., WebEx, Zoom, Chess, etc.) or application type (e.g., streaming, gaming, browsing, etc.).

For example, the C-DRX streaming profile may be designed for low-latency, high-speed data transfer; the browsing profile may be balanced between power saving and moderate latency; and the idle profile may be designed for maximum power saving when the device is not actively used. The network might select the streaming profile when the user starts streaming a video. The parameters defined in the streaming profile (e.g., shorter DRX cycles and small sleep periods) are instantiated as the current C-DRX configuration for the UE 104. This configuration may actively manage the UE's DRX behavior based on the streaming profile's settings.

C-DRX configuration may refer to the set of parameters (and their set values) applied to the UE 104 to manage its DRX behavior. The configuration includes specific values for various DRX parameters, such as ‘onDurationTimer,’ ‘drx-InactivityTimer,’ ‘drx-RetransmissionTimer,’ ‘longDRX-Cycle,’ ‘shortDRX-Cycle,’ and ‘drxShortCycleTimer.’ When a C-DRX profile is selected and applied, the predefined settings from the C-DRX profile are instantiated as the current C-DRX configuration. In this sense, the C-DRX configuration is the specific application of the profile's parameters to the device's current operating environment.

Currently, network operators control and configure C-DRX profiles statically and often manually, typically following a case-by-case negotiation between the UE vendors and the operator. Even when a service-specific, e.g., 5G QoS identifier (5QI)-specific, C-DRX profile is available, a one-size-fits-all approach is often adopted for categories of very different traffic patterns.

In some instances, different 5QI-specific C-DRX configuration profiles may be permitted by base station 108 or UE capabilities. However, defining these profiles may involve setting a large number of parameters across multiple dimensions (e.g., C-DRX cycle/periodicity, inactivity time, ON-duration, offset, wake-up signal (WUS) offset). The complexity of these parametric combinations makes it challenging to define an application-optimized profile manually.

Typically, only one configuration is provided to and supported by the UE 104. When multiple 5QI applications with corresponding C-DRX profiles are configured, the UE 104 may adopt the least stringent C-DRX profile, which is not optimal for all applications.

To address these issues, the UE 104 and base station 108 may semi-statically adjust or adopt a C-DRX configuration profile that is automated by paired AI-ML predictions to meet the current applications' QoS or QoE preferred parameters.

In some embodiments, e.g., UE standalone selection, the UE 104 may select a C-DRX profile from a list of network-approved C-DRX profiles. The UE 104 may use an AI-ML model to learn and classify an application to fit a 5QI-specific C-DRX configuration profile.

In some embodiments, e.g., UE-Network Paired Selection of AI-ML models, a C-DRX profile is selected and configured based on a semi-static, end-to-end synchronized, QoE-based AI/ML model. The AI-MI models are paired or federated and agreed upon by both the UE 104 and the base station 108.

In some embodiments, the UE 104 or the base station 108 may apply predictive dynamic switching between short and long C-DRX. The UE 104 may opportunistically enter long C-DRX earlier than it is configured based on known uplink and prediction of downlink traffic arrivals. The AI-ML model may be used to predict the downlink traffic arrivals.

In some embodiments, the base station 108 or the UE 104 may apply adjustment to C-DRX parameters. The adjustment may be explicit or implicit. In some embodiments, the UE 104 may extend the DRX inactivity timer or predict C-DRX wake-up signal (WUS) occurrences based on real-time traffic. In some embodiments, the UE 104 may map its application to a different data radio bearer (DRB), hence applying a different 5QI-specific C-DRX configuration. UE control messages, such as UE capability, may be used to inform the base station 108. The UE 104 may use control messages such as QoS-flow re-establishment or packet data unit (PDU) session modification signaling to reassign the application to a different DRB.

In some embodiments, the UE 104 and base station 108 may exchange one or more AI-ML models or information or indications associated with one or more AI-ML models. The AI-ML model may be encoded into structured format (e.g., Javascript object notation, JSON, extensible markup language, XML), binary format (e.g., open neural network exchange, ONNX), model-specific format (e.g., TensorFlow or TensorFlow Lite), intermediate representations (e.g., OpenVINO IR, or neural network exchange format, NNEF), or compressed format. These formats may be used to transmit and interpret models across different platforms.

The signaling for exchanging AI-ML models may be used to synchronize the UE 104 and base station 108 to agree or converge on AI-ML models for semi-statically selecting an application-specific or QoE-specific C-DRX profile. This approach enables an end-to-end (E2E) automatically converged or agreed C-DRX profile selection or adjustment through automated control messages or AI-ML models exchanged between the UE 104 and the network (e.g., base station 108, core network 112, or data network 120).

In some embodiments, the UE 104 and base station 108 may exchange control messages. UE 104 may generate and send control messages to base station 108 to indicate UE's capability to use the AI-ML model to predict or select C-DRX profiles. Once the UE 104 selects a C-DRX profile using the AI-ML model, UE 104 may generate and send control messages to base station 108 to request configuring the selected C-DRX profile.

In some embodiments, base station 108 may generate and send control messages to UE 104 to trigger AI-ML-based C-DRX profile selection or to configure UE 104 with a UE-selected C-DRX profile.

In some embodiments, inputs to selecting the C-DRX profile may include application traffic information, allowed 5QI, target QoE/KPI, cross-layer information, and the UE-network paired models.

By using control messages, adopting new implicit state change (C-DRX parameter adjustment), and introducing AI-ML model pairing, the UE 104 and base station 108 may achieve a semi-static, synchronized selection of the optimal C-DRX configuration. This may provide an efficient and adaptive C-DRX management tailored to specific applications and traffic patterns.

In some embodiments, both UE 104 and base station 108 models are developed by network vendors. The base station 108 may configure the UE 104 to run the AI-ML model at the UE side. In other embodiments, both UE 104 and base station 108 AI-ML models are developed by the UE vendor. The UE vendor may provide the AI-ML model to the base station 108. The same model may be provided to application servers or utilized by proxy servers. In another embodiment, the UE model and base station models are jointly trained. For example, the UE vendor may design the UE model, the network vendor may design a base station or network model, and the two models may be jointly trained.

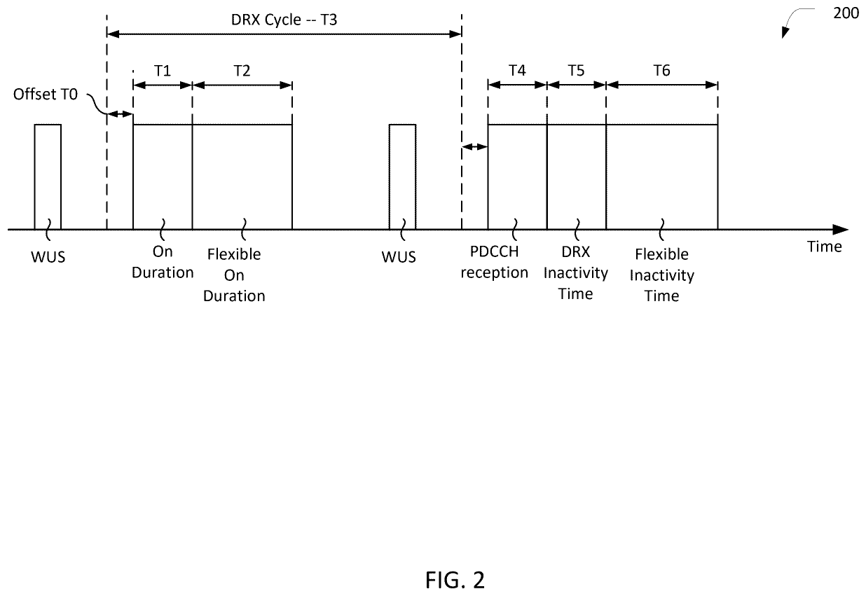

FIG. 2 illustrates a timing diagram 200 in accordance with some embodiments. Timing diagram 200 is an example of signals, timing, and durations associated with C-DRX operation.

Base station 108 may generate and transmit a wake-up signal (WUS) to notify UE 104 that it needs to wake up from its low-power state because there is incoming data or signaling information. WUS may serve as an early warning mechanism that reduces the need for the UE 104 to frequently wake up and check for data, thus conserving more battery. The static and periodic WUS cycle may not match the dynamic traffic pattern. The UE 104 may use the AI-ML model to configure a flexible WUS detection cycle. The UE 104 may decide, using the AI-ML model, whether to monitor a WUS cycle (or WUS occasion).

In some instances, C-DRX may operate without the WUS. The UE 104 may use its redefined wake-up schedule to check for incoming data. UE 104 may wake up at regular intervals (as defined by the DRX cycle) to listen to potential data transmission from base station 108.

The DRX cycle may start at a specific time, e.g., a particular slot or symbol within a frame or subframe, and lasts for a configured time T3. For example, an RRC parameter may configure the DRX cycle duration by drx-ShortCycle or the cycle length in drx-LongCycleStartOffset.

The offset is a parameter that defines how far into the DRX cycle the ON period begins. The offset may be used to synchronize the wake-up times of the UE 104 with the expected transmission times from the base station 108. The value of the offset (TO) may be configured by the base station 108. An RRC parameter, e.g., drx-longCycleStartOffset, may configure the value of the offset parameter of the C-DRX configuration.

The ON duration may be the time window within the DRX cycle during which the UE 104 is awake and actively monitors for data transmissions. The ON duration, T1, may be configured by the base station 108. An RRC parameter, e.g., onDurationTimer, may specify the length of the ON duration within each DRX cycle. A long ON duration may result in wasting UE power when there is no sufficient traffic. A short ON duration may result in increasing delay or latency, e.g., the UE 104 may miss DL traffic bursts.

In some embodiments, a flexible ON duration may be used after the configured ON duration. During the flexible ON duration period, T2 and UE 104 may decide whether to monitor DL transmissions, e.g., physical DL control channel (PDCCH). UE 104 may use AI-ML model prediction to determine whether to monitor PDCCH during the flexible ON duration. The AI-ML model may predict DL scheduling based on history traffic, channel status, QoS profile, active applications, vendor information, or cell load. When UE 104 is capable of configuring flexible ON duration, the configured ON duration in the C-DRX profile may be configured with a smaller duration (in comparison to a C-DRX without flexible ON duration).

In some embodiments, when WUS is not detected, the UE 104 may monitor ON duration based on AI-ML model output. The AI-ML model configuration and usage are similar to the AI-ML model configuring the flexible ON duration.

After receiving data in the ON duration, e.g., T4, the UE 104 may start a DRX inactivity timer. An RRC parameter, e.g., drx-InactivityTimer, may configure the inactivity timer, T5. The inactivity timer may determine how long the UE 104 remains in an active state, e.g., not entering the DRX sleep mode) after receiving data from base station 108. When the inactivity timer expires, the UE 104 may transition to the DRX sleep mode. If another data packet or control message is received before the timer expires, the timer may be reset, and the UE 104 may remain in the active state.

An inactivity timer with a long duration may result in wasting the UE 104 power when the UE 104 does not have sufficient UL or DL traffic. An activity timer with a short duration may result in increased latency or delay.

In some embodiments, a flexible DRX inactivity period, T6, may be used after the configured DRX inactivity timer expires. During the flexible DRX inactivity period, T6 UE 104 may decide whether to monitor DL transmissions, e.g., physical DL control channel (PDCCH). UE 104 may use AI-ML model prediction to determine whether to monitor PDCCH during the flexible inactivity period. The AI-ML model may predict DL scheduling based on history traffic, channel status, QoS profile, active applications, vendor information, or cell load. When UE 104 is capable of configuring a flexible inactivity timer, the configured inactivity timer in the C-DRX profile may be configured with a smaller duration (in comparison to a C-DRX without a flexible inactivity timer).

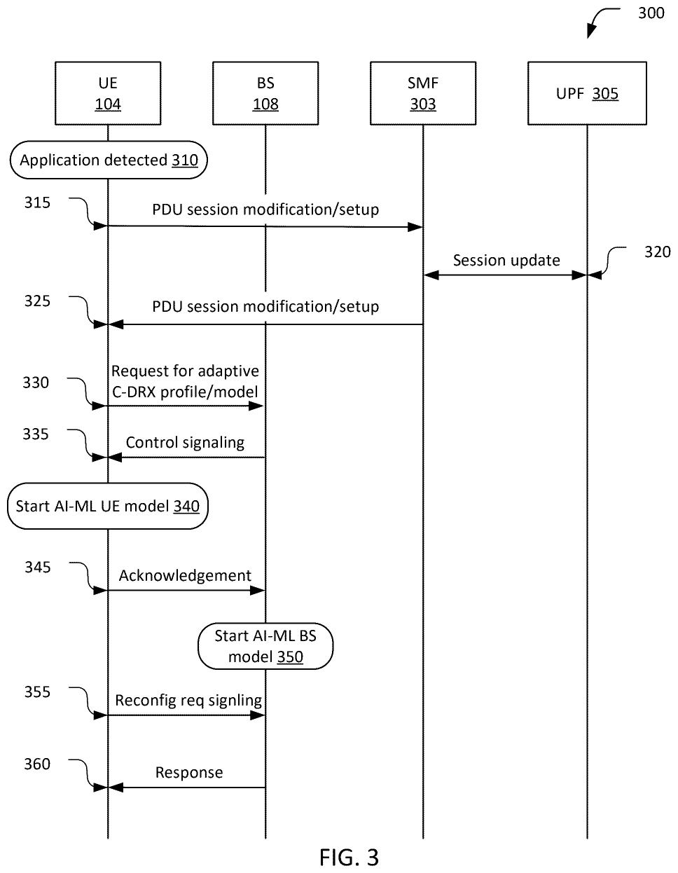

FIG. 3 illustrates a signaling diagram 300 in accordance with some embodiments. Signaling diagram 300 is an example of a semi-dynamic adaptive C-DRX profile selection based on an automated UE-Network AI-ML model.

The signaling diagram 300 may include signals generated or processed by UE 104, base station 108, session management function 303, and the user plane function (UPF) 305. The SMF 303 may be responsible for managing PDU sessions, enforcing QoS policies and data path routing policies, handling the allocation and releasing of Internet Protocol (IP) addresses, and interacting with other functions such as access and mobility management function (AMF) or UPF 305. UPF 305 may handle the user plane traffic, including forwarding of user data packets between the UE 104 and external data network, e.g., data network 120.

At 310, UE 104 detects data from an application (e.g., a video streaming or gaming application). UE 104 may monitor active processes and applications running on the device, e.g., via the operating system (OS), which may provide information about applications that are generating network traffic.

At 315, UE 104 may generate and send a request for QoS flow (e.g., 5QI mapping) setup to SMF 303. The SMF 303 may establish a new PDU session or QoS flow or modify existing PDU sessions, or QoS flows based on the application data traffic.

At 320, once the application data traffic is mapped to a QoS flow, the SMF 303 may generate and send a message to UPF 305 to configure UPF 305 to handle data forwarding according to the QoS parameters, including the 5QI. The UPF 305 may enforce the QoS policies as instructed by the SMF 303. Upon receiving the configuration instructions, the UPF 305 may process the information and set up the necessary data paths and policies. The UPF 305 may send an acknowledgment message to the SMF 303 to confirm that the configuration has been successfully applied.

At 325, SMF 303 may send a session establishment or modification response to the UE 104. SMF 303 may send the response via AMF, indicating that the session has been successfully established or modified. The response may provide information regarding the allocated QoS parameters and 5QI.

At 330, the UE may generate and send a message to base station 108. The message may include a request for one or more adaptive C-DRX configuration profiles or a pairing of one or more AI-ML models. Pairing in this context may refer to jointly developing or selecting an AI-ML model by the UE 104 and the network (e.g., base station 108 or core network 112), selecting or configuring an AI-ML model at the UE 104 that is associated with an AI-ML model at the base station 108, or selecting or configuring an AI-ML model at the base station 108 that is associated with an AI-ML model at the UE 104. The request may include information on one or more preferred or modified C-DRX profiles. The request may include one or more AI-ML models or information associated with one or more AI-ML models. The C-DRX profiles or AI-ML models indicated by the message may be application-specific and selected based on the application category, QoS, or QoE parameters of the application data traffic.

The message at 330 may be an uplink control information (UCI) or a medium access control (MAC) control element (CE).

At 335, base station 108 may send one or more control messages to UE 104. The control messages may include information or indications associated with one or more C-DRX profiles or one or more AI-ML models. For example, the control message may include the C-DRX profile, or an index or indication associated with a C-DRX profile. Similarly, the control message may include a representation of an AI-ML model or an index or indication referring to a predefined or preconfigured AI-ML model. In some embodiments, the steps at 330 and 335 may repeat, and it may take several rounds of signaling exchange between UE 104 and base station 108 until both UE 104 and base station 108 agree or converge on C-DRX profiles or AI-ML models.

The control signaling at 335 may be a downlink control information (DCI), an RRC signaling (e.g., RRC reconfiguration), a MAC CE, or a hypertext transfer protocol (HTTP) message.

In some embodiments, base station 108 may trigger application-specific C-DRX profile or AI-ML model pairing. Base station 108 may trigger application-specific C-DRX profile or AI-ML model pairing by generating and sending the control message, including C-DRX profiles or AI-ML models, to the UE 104 without receiving any request (e.g., the message sent by the UE 104 at 330) from UE 104.

At 340, UE 104 may start the AI-ML model. At 345, after the successful start of the AI-ML model, UE 104 may confirm the configuration by sending a response to base station 108. For example, UE 104 may send an RRC reconfiguration complete message to base station 108.

At 350, base station 108 may start the paired AI-ML model. The base station 108 may start AI-ML before or after receiving UE's response at 345.

UE 104 may select a C-DRX profile based on its AI-ML model. AI-ML model may take application data traffic or layer 1, 2, or 3 (L1, L2, or L3) measurements (e.g., buffer status report, buffer backlog, channel state information, etc.) as input for selecting a C-DRX profile. UE 104 may revise the AI-ML model parameters and provide them to base station 108.

At 355, UE 104 may send a reconfiguration request signaling to base station 108. The reconfiguration request may include information associated with the selected C-DRX or revised AI-ML model parameters. The reconfiguration request may be a MAC CE or a UCI message. UE 104 may encode C-DRX information (may be referred to as C-DRX assistance information) and AI-ML model information.

At 360, in response to receiving, processing, or decoding the reconfiguration request by UE 104, base station 108 may send a response to UE 104. The response may include one or more commands associated with the C-DRX and AI-ML models to reconfigure the UE 104. The C-DRX or AI-ML models may be based on the AI-ML model running on the base station 108 or the C-DRX profile or AI-ML model indicated by the UE in the reconfiguration request. The response may be a DCI, MAC CE, RRC signaling, or an HTTP command.

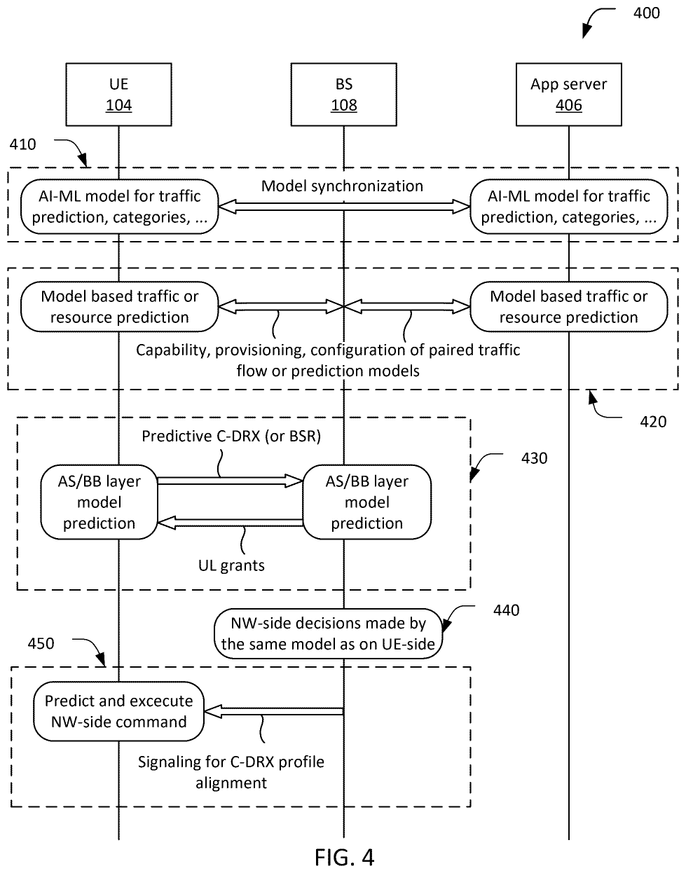

FIG. 4 illustrates an operation diagram 400 in accordance with some embodiments. Operation diagram 400 may include signaling and operations at application server 406.

At 410, UE 104 and application server 406 may exchange messages to synchronize on a paired AI-ML model for traffic prediction or classification of application or data traffic category. The synchronization may be initiated or triggered by the application server 406 or by the UE 104. The AI-ML model may be used to predict peak traffic, traffic bursts, or other characteristics of application data traffic. The AI-ML model may also be used to classify or identify the category of the application or application data traffic (e.g., video streaming, gaming, browsing, or other categories).

At 420, the UE 104, base station 108, or application server 406 may exchange messages to synchronize on the AI-ML model for traffic or resource prediction. The messages may include capabilities, provisioning, configuration, paired models, or predicted traffic flows.

The AI-ML model may be the same as the AI-ML model in step 410 or may be different. The AI-ML model may be used in this operation to predict the resources for application data traffic. At 410, the application server 406 may access relevant information related to application data patterns and may be in a better position to develop an AI-ML model for traffic prediction and categorization. At 420, the AI-ML model may be used for resource prediction or scheduling information. UE 104 and base station 108 may have more access to data related to UE 104 or base station 108 capabilities, configurations, or scheduling and provisioning data and may be in a better position (compared to application server 406) to develop the AI-ML model for resource prediction.

At 430, the paired AI-ML model may be developed or synchronized for access stratum (AS) or baseband (BB) layer predictions, e.g., predicting the generation and transmission of UL or DL scheduling signaling, UL scheduling requests, or buffer status report (BSR). The AI-ML model may be used to select and configure predictive C-DRX profile or buffer status report configurations.

At 440, the network (e.g., base station 108 or core network 112) may generate decisions and predictions using the same AI-ML model as UE 104.

At 450, the UE may predict and execute commands from base station 108, e.g., signaling for C-DRX profile alignment.

Operations in operation diagram 400 may provide an end-to-end, cross-layer, cross-device coordination for predictively optimized network control behavior. For example, operations at 430 or 450 may establish an L1, L2, or L3 synchronized predictive control between the UE 104 and base station 108. The upper-layer information and data may be used to train and select an AI-ML model used for lower-layer predictions. For example, application layer data related to traffic activities may be used for predictive transceiver operations, RRC state transition, BSR prediction, bandwidth part (BWP) switching, or handover (HO) procedure.

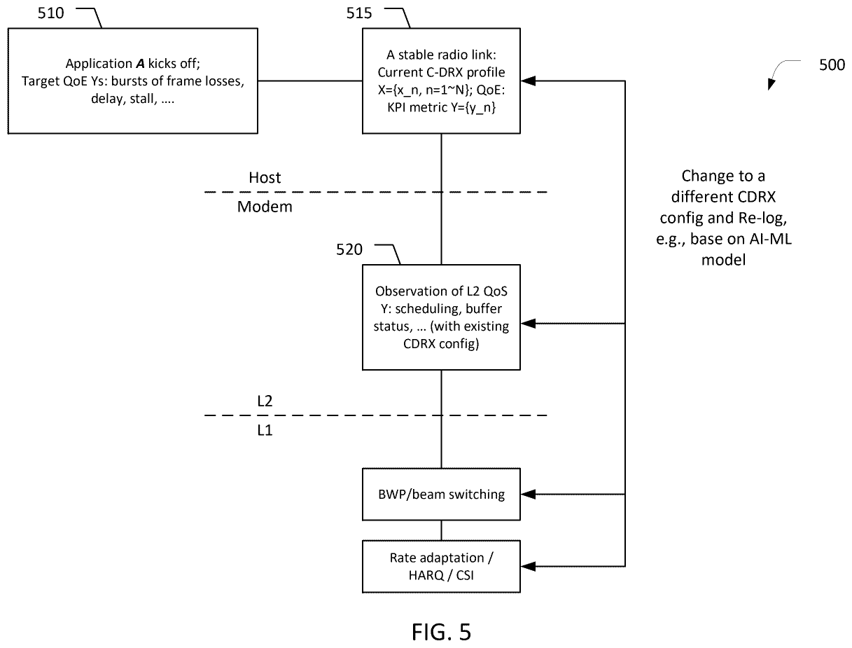

FIG. 5 illustrates a dataset pipeline 500 in accordance with some embodiments. Dataset 500 illustrates example sources of data used for training, updating, or selecting the AI-ML model.

The device (e.g., UE 104) may include a host and modem. The host may be responsible for running the application and operating system. The modem may include the implementation of the protocol stack, e.g., L1 or L2.

At 510, an application denoted by application A may be associated with target QoE parameters such as bursts of frame losses, delay, bit rate, or reliability. The set of target QoE or QoS parameters may be represented by scaler (for a single parameter) or set (for multiple parameters) Y in FIG. 5. At 520, the collected data is the known performance indicator (KPI), e.g., L2 measurement data related to the L2 QoS/QoE parameter, Y. Data may include scheduling information, buffer status information, and latency or reliability measurements based on the current C-DRX profile or configuration.

At 515, a C-DRX profile, denoted by X={x_n, n=1˜N}, where x_n indicates a C-DRX profile parameter, for the application A, with QoE KPI metric, Y={y_n}, is selected or configured to achieve the objective trade-off between performance and power saving is the output of the C-DRX selection process. UE 104 and base station 108 may leverage cross-layer correlated measurements and data sets to train or develop an AI-ML model for selecting or configuring the C-DRX profile X. The AI-ML model or the selected C-DRX profile is an application-specific, e.g., developed for application A, which may achieve or outperform the target QoE/QoS preferred parameters Y.

L1 measurements associated with the target QoS/QoE preferred parameters may also be used to train the AI-ML model. For example, L1 measurement associated with bandwidth part switching or beam management, such as L1-reference signal received power (L1-RSRP), may be used to train or develop an AI-ML model. Other L1 measurements, such as rate adaptation, hybrid automatic repeat request (HARQ), or channel state information (CSI), may also be considered in determining the AI-ML model.

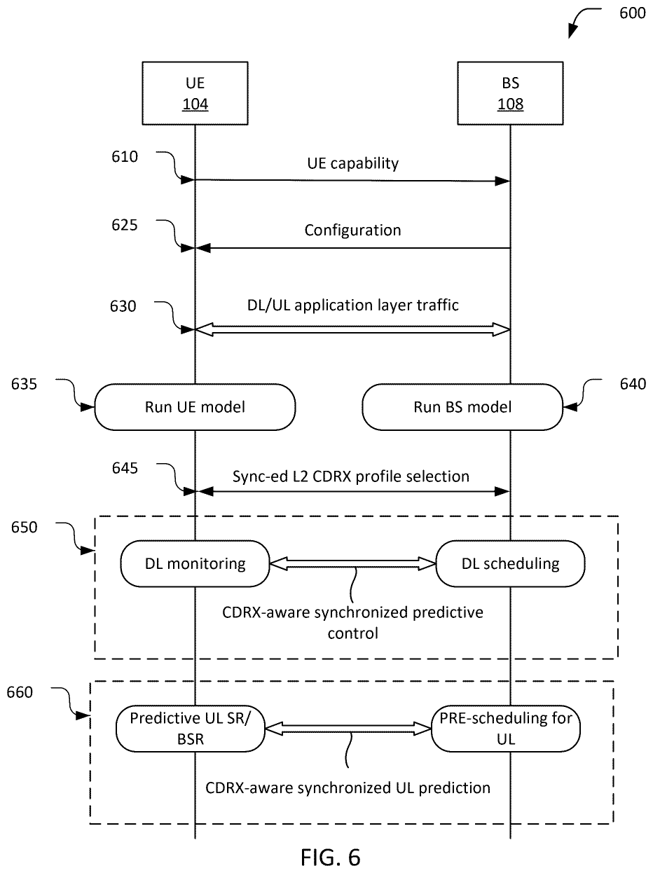

FIG. 6 illustrates another signaling diagram 600 in accordance with some embodiments. Signaling diagram 600 is an example of control signaling that may be used to configure and use the AI-ML model. It is assumed that the AI-ML models are developed, and the signaling is used to configure the UE 104 with an application-specific AI-ML model.

At 610, UE 104 may send a message including UE capabilities to the base station 108. The UE capability may indicate a capability of using an AI-ML model, e.g., to select a C-DRX profile, predict traffic patterns, or DL/UL scheduling signaling or data traffic.

At 620, and based on UE capabilities, the base station 108 may configure the UE 104. Configuration may include DRX configuration, one or more AI-ML models, and target parameters such as traffic categories or flow identifiers (ID). Base station 108 may use RRC signaling, e.g., RRC reconfiguration, to configure the UE 104. The AI-ML models may be used for C-DRX profile selection or synchronized scheduling prediction, e.g., predicting UL/DL scheduling signaling or data traffic. In some embodiments, the AI-ML models may be used to decide whether to wake up based on AI-ML traffic predictions. In some embodiments, the AI-ML may be used to predict or select DRX profiles with parameters such as ON duration, short cycle, or long cycle.

At 630, the UE 104 and base station 108 may exchange DL and UL application layer traffic. At 635, the UE 104 may run the AI-ML model; at 640, the base station 108 may run the paired AI-ML model.

At 645, through a series of signaling between UE 104 and base station 108, a synchronized application-specific C-DRX profile may be selected. In some embodiments, the UE 104 may select the C-DRX profile using the AI-ML model and request the base station 108 to reconfigure the UE 104 with the selected C-DRX. The base station 108 may validate, update, or select a different C-DRX profile based on the information received from the UE 104 and the AI-ML model running locally. The base station 108 may configure (or reconfigure) the UE 104 with the validated, modified, or new C-DRX determined base station 108.

In some instances, if the network detects UE 104 has missed too many grants or DL data, base station 10 may reconfigure the UE 104 to fallback to a default DRX configuration. If the UE misses too many scheduling opportunities in a C-DRX cycle, the UE 104 may trigger another iteration of AI-ML model pairing that may lead to another C-DRX prediction and profile selection round. UE 104 and base station 108 may perform synchronized L1/L2 UL/DL scheduling in a predictive manner, e.g., based on known C-DRX profile and traffic. For example, at 650, the UE 104 may determine DL scheduling or control transmission using a C-DRX-aware synchronized L1 or L2 DL predictive AI-ML model. UE 104 may wake up based on the prediction and monitor the DL control channel, e.g., the physical downlink control channel (PDCCH). Similarly, at 660, the UE 104 may determine UL scheduling or control transmission using a C-DRX-aware synchronized L1 or L2 DL predictive AI-ML model. The UE 104 may wake up for transmission of the scheduling request (SR) or the buffer status report or may extend the ON duration, e.g., flexible ON duration, for transmission predictive UL SR or BSR, or for monitoring and receiving PDCCH.

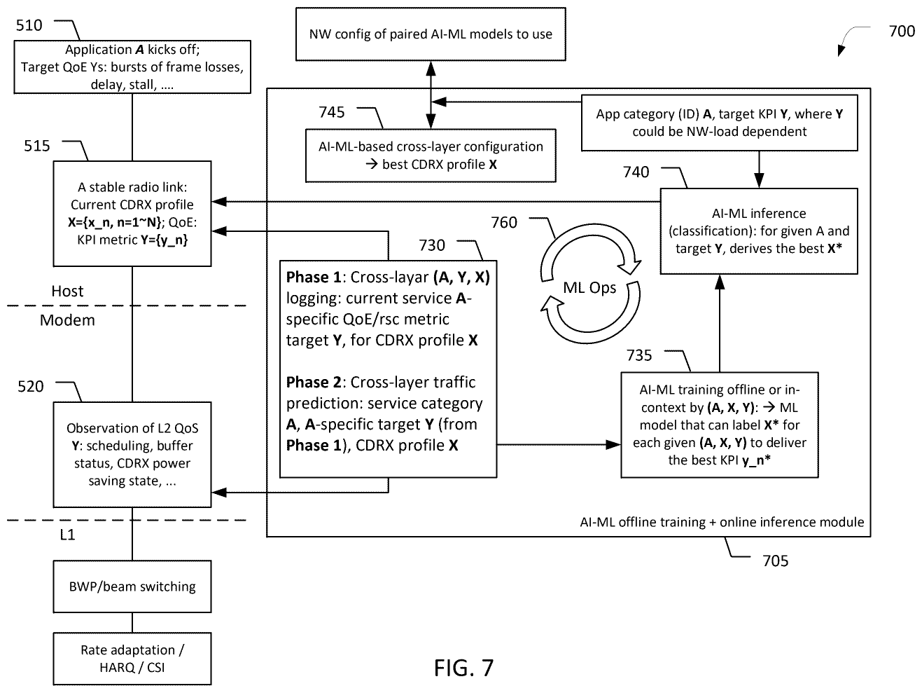

FIG. 7 illustrates another operation diagram 700 in accordance with some embodiments. Operation diagram 700 may be an example of training the AI-ML model and performing the AI-ML-based C-DRX profile prediction operation by the UE 104.

Operations at 510, 515, and 520 are substantially similar to those described in FIG. 5. Prediction and pairing operations are performed by module 705. A module may include hardware logic, circuitry, or software to provide functionalities, signaling, and information exchanged with other modules or components. Module 705 may include AI-ML offline training and perform online inference.

The operations are divided into two phases: in Phase 1, the AI-ML model is trained, and in Phase 2, the AI-ML model is used for online prediction.

### Phase 1

As described in FIG. 5. Operations at 510, 515, and 520 collectively determine the input parameters to the AI-ML model, which are L1/L2 measurements, application A, target QoE/QoS Y, and the output is the C-DRX profile X. Module 705 may include a cross-layer logging operation that may log the current service specific QoE measurements, and the target QoE Y, for the current C-DRX profile X.

Module 705 may receive a network-configured AI-ML model. The objective may be to determine an AI-ML model that is going to be paired with the network-configured AI-ML model.

Module 705 may include an offline AI-ML training module 735. Module 735 may receive the logging information from module 730 and determine an AI-ML model that can generate C-DRX profile X* for a given (A, X, Y). The trained AI-ML model would generate a C-DRX profile X* such that the QoE obtained by X*, denoted by y_n*, is closer to the target QoE Y than the QoE obtained by the current C-DRX profile X.

Module 740 may receive the AI-ML model to perform inference or classification for a given application, A, with target QoE Y. Module 740 may receive real-time information such as application category ID, target QoE Y of the application running on the device, and L1/L2 measurements.

Module 745 may obtain the best C-DRX profile that may provide or outperform target QoE Y. Module 745 may configure module 515 with the selected or determined C-DRX profile. The selected C-DRX profile may be computed by considering cross-layer inputs, such as L1 radio link information, application-layer traffic, QoE dynamics, or L2 QoS or resource dynamics. The trained AI-ML model may have multiple purposes or multiple models, each for a different purpose. For example, the AI-ML model may be a paired model for traffic or load prediction of a specific application or application type, a paired model for QoE prediction, a paired model for L2 resource prediction, or a paired model for C-DRX profile selection.

### Phase 2

ML operations (Ops) 760 may be used for online training and continuous learning. ML Ops 760 may include real-time data ingestion, data processing, incremental learning, model validation and deployment, and workflow management. Module 705 may receive data in real-time from the modem and host, e.g., L1/L2 measurements as well as application traffic information. Automated processing may transform the data before feeding into the training pipeline. Using algorithms designed for incremental updates, such as online gradient descent, the AI-ML model is continuously updated with new data.

During phase 2, at 730, using the information at 515 or 520, a prediction (e.g., a cross-layer traffic prediction, application traffic prediction, QoE prediction, KPI prediction, etc.) is used to determine a candidate C-DRX profile, X. For example, the prediction is used to determine a service category of the application A. The service category may determine an application-specific (e.g., A-specific) target QoE, Y (e.g., from phase 1). Using the service category or the application-specific target QoE, a C-DRX profile may be determined or selected.

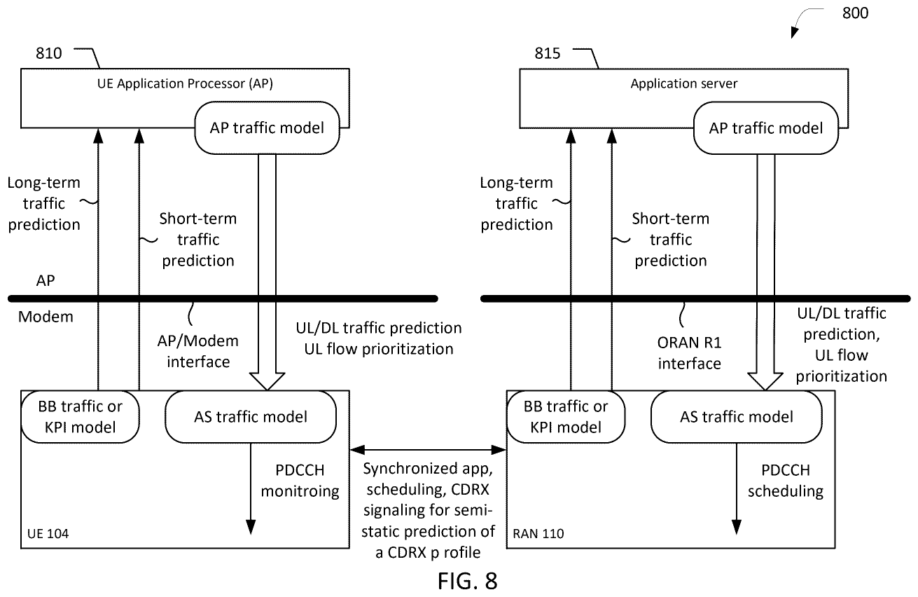

FIG. 8 illustrates another signaling diagram 800 in accordance with some embodiments. Signaling diagram 800 may be an example of a pairing mechanism for AI-ML models for predictive C-DRX profile selection.

On the UE-side, several models may be developed and used. For example, the application traffic model may be used to monitor and predict the application data traffic of the UE application processor (AP) 810. Similarly, on the modem side of the UE 104, other AI-ML models may be used for UL/DL traffic prediction (as shown in FIG. 8), application-layer QoE KPIs or L2 KPIs prediction (not shown), or UL/DL flow prioritization. The AP traffic model, or UL/DL traffic prediction model, may be used for short-term or long-term traffic predictions. For example, UE 104 may include a baseband (BB) traffic model that may predict long-term traffic prediction. The BB traffic model may use the application or UL/DL traffic prediction models. UE 104 may include an access stratum (AS) traffic model that may be used for short-term traffic prediction. The AS traffic model may also be used to determine a C-DRX that matches the predicted traffic model and control channel monitoring predictions.

Similarly, on the base station side, several models may be developed and used. For example, the application traffic model may be used to monitor and predict the application data traffic at the RAN 110 of the application server 815. Similarly, on the air interface side of the RAN 110, other AI-ML models may be used for UL/DL traffic prediction or UL/DL flow prioritization. The AP traffic model or UL/DL traffic prediction model may be used for short-term or long-term traffic predictions. For example, RAN 110 may include a baseband (BB) traffic model that may predict long-term traffic prediction. The BB traffic model may use the application or UL/DL traffic prediction models. UE 104 may include an AS traffic model that may be used for short-term traffic prediction. The AS traffic model may also be used to determine a C-DRX that matches the predicted traffic model and control channel monitoring predictions.

UE 104 and RAN 110 may exchange synchronized application, scheduling, or C-DRX signaling to perform semi-static C-DRX profile prediction. The UE 104 and RAN 110 signaling may be an RRC signaling, MAC CE, UCI, DCI, HTTP, or AS signaling to pair AI-ML models for end-to-end C-DRX configuration or switch dynamically.

A generic mechanism to enable accurately predictive end-to-end C-DRX control may include adopting a synchronization mechanism among the involved devices, e.g., UE 104 and base station 108. The AI-ML models may be applied for cross-layer predictive C-DRX profile reselection or reconfiguration based on application traffic (e.g., traces, events, or patterns), L1/L2 buffer backlog (e.g., resource occupancy), or scheduling of resources or consequentially L1/L2 UL/DL traffic streams (e.g., UL BSR, or DL traffic arrival). The model pairing or control synchronization may be achieved by real-time message signaling or configuration, e.g., by standard specifications such as those of HTTP, L2 AS, L2 MAC CE, and L1 UCI/DCI.

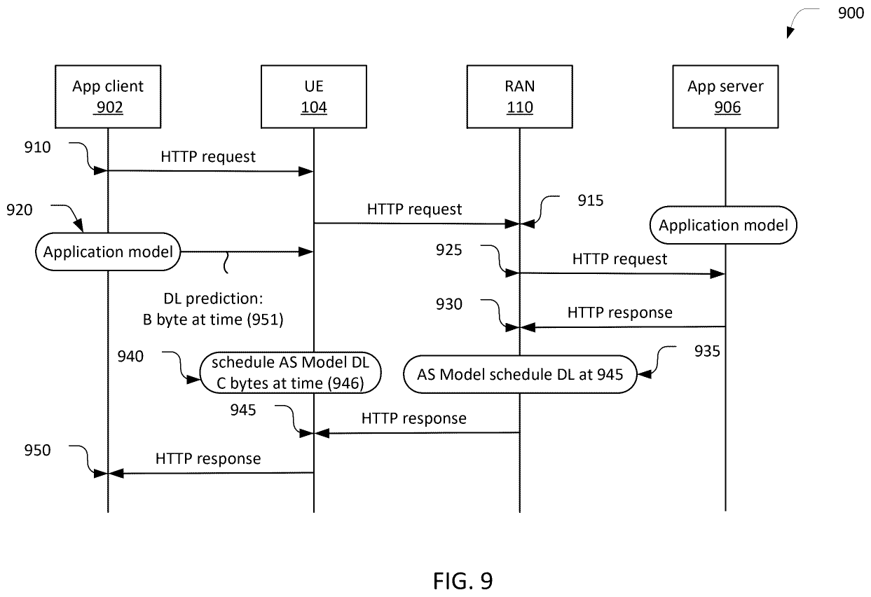

FIG. 9 illustrates another signaling diagram 900 in accordance with some embodiments. Signaling diagram 900 is an example of using HTTP signaling for end-to-end model pairing. The signaling diagram 900 may include messages to or from application client 902, UE 104, RAN 110, or application server 906. Application server 906 may be an example of application server 815 in FIG. 8. Application client 902 may run on the same device as UE 104 or may run on an accessory device connected to the UE 104 device.

At 910, application client 902 may generate and send an HTTP request. HTTP request may be sent to server 906 to request data or perform an action. For example, an HTTP request may be a get, post, put, or delete command. UE 104 may receive and process the HTTP request from the application client 902.

At 915, UE 104 may generate and send (e.g., forward) the HTTP request to RAN 110. RAN 110 may receive and process the HTTP request sent by UE 104.

At 920, application client 902 may run an AI-ML application model. The AI-ML application model may predict a DL transmission of size B bytes at time 951. Application server 906 may run the AI-ML model. The synchronized AI-ML model is used to predict DL (or UL) traffic or KPIs for the purpose of QoE-awareness and C-DRX profile selection.

At 925, RAN 110 may generate and send (e.g., forward) the HTTP request to application server 906. Application server 906 may receive and process the HTTP request sent by RAN 110.

At 930, application server 906 may generate and send an HTTP response to RAN 110. The HTTP response may be based on the received HTTP request. RAN 110 may receive and process HTTP responses sent by the application server 906.

At 935, RAN 110 may use the AS model to schedule DL transmission at 945.

At 940, UE 104 may predict a scheduled DL using the AS Model. The prediction may indicate a DL transmission of C bytes at time 946.

AT 945, RAN 110 may generate and send (e.g., forward) the HTTP response to UE 104. UE 104 may receive and process the HTTP response sent by RAN 110. The predicted DL transmission time of 946 may be similar to or close to the received time at 945.

At 950, UE 104 may generate and send (e.g., forward) the HTTP response to application client 902. The application client 902 may receive and process the HTTP request sent by UE 104. The reception time of the HTTP request at 950 may be similar to or close to the predicted DL transmission at time 951.

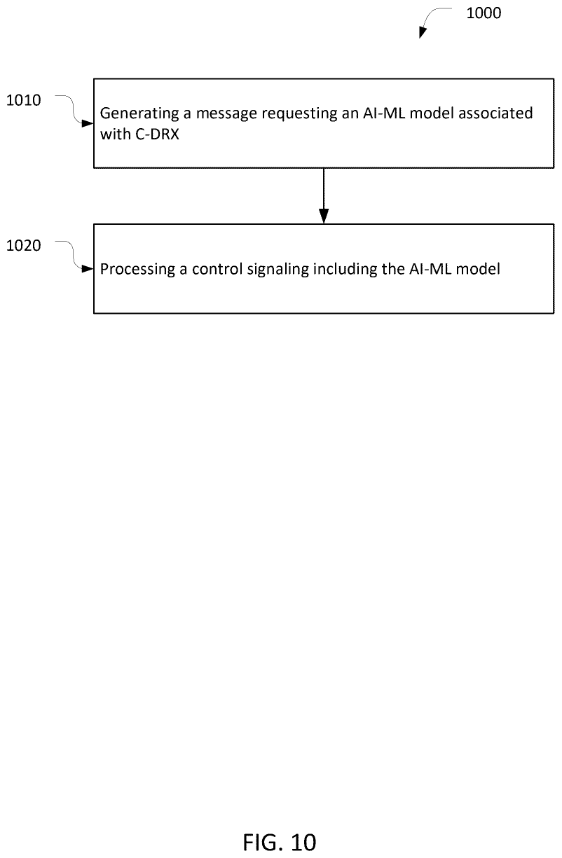

FIG. 10 illustrates an operation flow/algorithmic structure 1000 in accordance with some embodiments. The operation flow/algorithmic structure 1000 may be performed or implemented by a UE such as, for example, the UE 104 or UE 1400; or components thereof, for example, baseband processor circuitry 1404A.

The operation flow/algorithmic structure 1000 may include, at 1010, generating a message requesting an AI-ML model. The request AI-ML model may be associated with a C-DRX profile or a network control. The network control may be a channel state information (CSI) scheduling, a buffer status report (BSR) scheduling, a downlink scheduling, a traffic prediction, a QoE prediction, or a buffer state prediction. UE 104 may generate a message. The message may include an indication requesting one or more C-DRX profiles. The message may include C-DRX assistance information and AI-ML information. C-DRX assistance information may include C-DRX profile parameters or information associated with C-DRX profiles, e.g., application type, target QoE, or L1/L2 measurements. The message may be a UCI, MAC CE, or HTTP.

UE 104 may generate and send the message to a network node. The network node may be the base station 108, RAN 110, core network 112, external data network 120, SMF 303, UPF 305, or application server 406 or 906.

The operation flow/algorithmic structure 1000 may include, at 1020, processing or receiving a control signaling, including an indication of the AI-ML model. The control signaling may include the AI-ML or may include an index or an indication of the AI-ML model.

In some embodiments, the UE 104 may select the C-DRX profile from one or more C-DRX profiles based on the AI-ML model.

In some embodiments, the UE 104 may generate another message requesting a reconfiguration based on the selected C-DRX profile.

In some embodiments, the UE 104 may receive and process a response, including a reconfiguration command based on the C-DRX profile. In response to the reconfiguration request, base station 108 may generate and send a reconfiguration signal to UE 104. The reconfiguration message may be an RRC reconfiguration message.

The message sent by the UE 104 may include an indication of an AI-ML model, a representation of the AI-ML model, an indication of another AI-ML model, or a representation of another AI-ML model.

The UE 104 may determine that the number of undetected scheduling messages or opportunities is larger than a threshold. The UE 104 may generate another message requesting a second AI-ML model to update or reconfigure the AI-ML model.

In some embodiments, the UE 104 may generate and transmit a UE capability report. The UE capability report may indicate whether the UE supports AI-ML C-DRX profile selection.

In some embodiments, the message may include an indication of an application. The indication of the application may be an application category (e.g., gaming, streaming, browsing, etc.).

In some embodiments, the UE 104 may perform data collection. The data collection may be a cross-layer data collection. The data may be associated with time-associated data such as known performance indication (KPI) metrics, trace logs, or event data. The UE 104 or the network may use the collected data to train the AI-ML model.

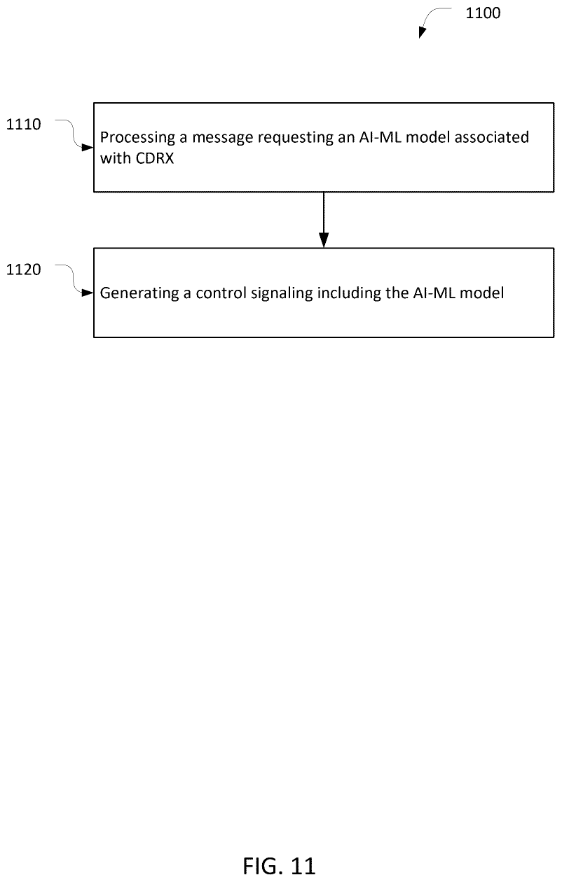

FIG. 11 illustrates an operational flow/algorithmic structure 1100 in accordance with some embodiments. The operation flow/algorithmic structure 1100 may be performed or implemented by a network node (e.g., a base station, an SMF, a UPF, or an application server) such as, for example, the base station 108 or the network device 1500; or components thereof, for example, baseband processor circuitry 1504A.

The operation flow/algorithmic structure 1100 may include, at 1110, processing a message requesting an AI-ML model. The message may be associated with a C-DRX profile or a network control. The network control may be SCI scheduling, BSR scheduling, downlink scheduling, traffic prediction, QoE prediction, or buffer state prediction. A network node may receive and process the message sent by the UE 104. The message may include an indication requesting one or more C-DRX profiles. The message may include C-DRX assistance information and AI-ML information. C-DRX assistance information may include C-DRX profile parameters or information associated with C-DRX profiles, e.g., application type, target QoE, or L1/L2 measurements. The message may be a UCI, MAC CE, or HTTP.

The network node may receive and process the message. The network node may be the base station 108, RAN 110, core network 112, external data network 120, SMF 303, UPF 305, or application server 406 or 906.

The operation flow/algorithmic structure 1100 may include, at 1120, generating or transmitting a control signaling, including an indication of the AI-ML model. The control signaling may include the AI-ML or may include an index or an indication of the AI-ML model.

In some embodiments, the network node may receive and process another message requesting a reconfiguration based on a C-DRX profile.

In some embodiments, the network node may generate and transmit a response, including a reconfiguration command based on the C-DRX profile. In response to the reconfiguration request, the network node may generate and send a reconfiguration signal to UE 104. The reconfiguration message may be an RRC reconfiguration message.

The message received and processed by the network node may include an indication of an AI-ML model, a representation of the AI-ML model, an indication of another AI-ML model, or a representation of another AI-ML model.

The network node may receive and process another message requesting a second AI-ML model to update or reconfigure the AI-ML model.

In some embodiments, the network node may receive and process a UE capability report. The UE capability report may indicate whether the UE supports AI-ML C-DRX profile selection.

In some embodiments, the message may include an indication of an application. The indication of the application may be an application category (e.g., gaming, streaming, browsing, etc.)

In some embodiments, the network node may perform data collection. The data collection may be a cross-layer data collection. The data may be associated with time-associated data such as known performance indication (KPI) metrics, trace logs, or event data. The UE 104 or the network may use the collected data to train the AI-ML model.

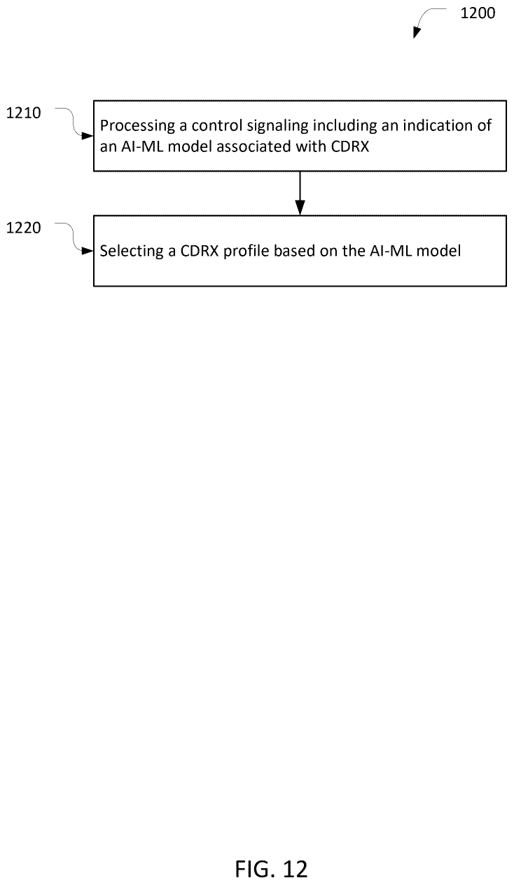

FIG. 12 illustrates an operation flow/algorithmic structure 1200 in accordance with some embodiments. The operation flow/algorithmic structure 1200 may be performed or implemented by a UE such as, for example, the UE 104 or UE 1400; or components thereof, for example, baseband processor circuitry 1404A.

The operation flow/algorithmic structure 1200 may include, at 1210, processing a control signaling, including an indication of an AI-ML model. UE 104 may receive and process a control signaling. The control signaling may include one or more AI-ML models or one or more indications of one or more AI-ML models.

The operation flow/algorithmic structure 1200 may include, at 1220, selecting the C-DRX profile from one or more C-DRX profiles based on the AI-ML model. UE 104 may use the AI-ML model to select a C-DRX profile.

In some embodiments, the UE 104 may generate and transmit a message requesting a reconfiguration based on the selected C-DRX profile.

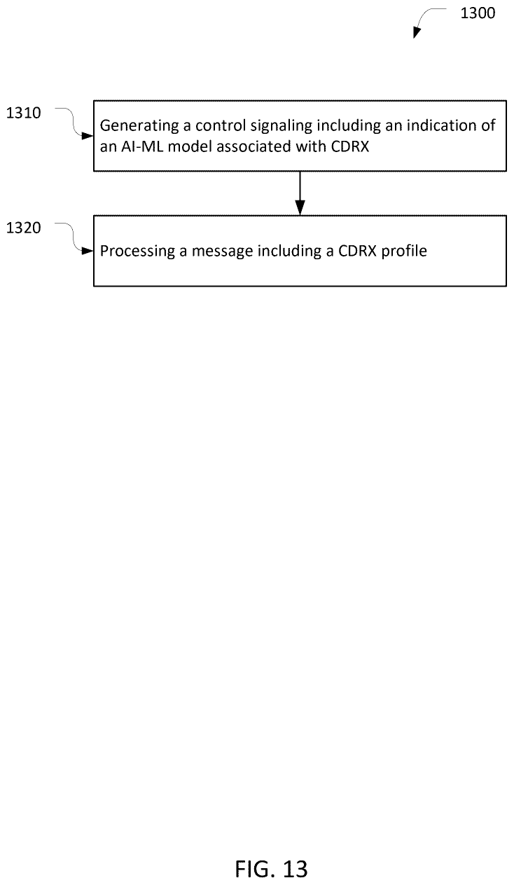

FIG. 13 illustrates an operational flow/algorithmic structure 1300 in accordance with some embodiments. The operation flow/algorithmic structure 1300 may be performed or implemented by a base station such as, for example, the base station 108 or the network device 1500; or components thereof, for example, baseband processor circuitry 1504A.

The operation flow/algorithmic structure 1300 may include, at 1310, at 1310, generating a control signaling, including an indication of an AI-ML model. Network node may generate and transmit a control signaling. The control signaling may include one or more AI-ML models or one or more indications of one or more AI-ML models.

The operation flow/algorithmic structure 1300 may include, at 1320, processing a message. The network node may receive and process the message sent by the UE 104. The message may include an indication of the C-DRX profile. The message may request a reconfiguration operation based on the C-DRX profile.

In some embodiments, the network node may generate a response that includes a reconfiguration command based on the C-DRX profile.

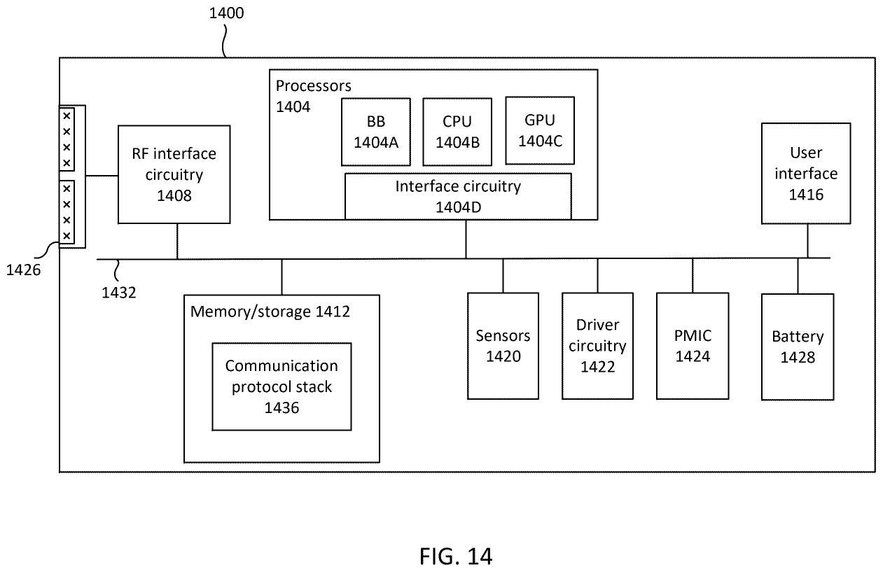

FIG. 14 illustrates a UE 1400 in accordance with some embodiments. The UE 1400 may be similar to and substantially interchangeable with the UE 104.

The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1400 may include processors 1404, RF interface circuitry 1408, memory/storage 1412, user interface 1416, sensors 1420, driver circuitry 1422, power management integrated circuit (PMIC) 1424, antenna 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry, or processor circuitry that executes or otherwise operates computer-executable instructions, such as program code, software modules, or functional processes from memory/storage 1412 to cause the UE 1400 to perform operations as described herein. The processors 1404 may also include interface circuitry 1404D to communicatively couple the processor circuitry with one or more other components of the UE 1400.

In some embodiments, the baseband processor circuitry 1404A may access a communication protocol stack 1436 in the memory/storage 1412 to communicate over a 3GPP-compatible network. In general, the baseband processor circuitry 1404A may access the communication protocol stack 1436 to: perform user plane functions at a PHY layer, MAC layer, RLC layer, PDCP layer, SDAP layer, and PDU layer and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 1412 may include one or more non-transitory, computer-readable media that include instructions (for example, communication protocol stack 1436) that may be executed by one or more of the processors 1404 to cause the UE 1400 to perform various operations described herein.

The memory/storage 1412 includes any type of volatile or non-volatile memory that may be distributed throughout the UE 1400. In some embodiments, some of the memory/storage 1412 may be located on the processors 1404 themselves (for example, memory/storage 1412 may be part of a chipset that corresponds to the baseband processor circuitry 1404A), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1426.

In various embodiments, the RF interface circuitry 1408 may be configured to transmit/receive signals in a manner compatible with NR access technologies.

The antenna 1426 may include antenna elements to convert electrical signals into radio waves to travel through the air and to convert received radio waves into electrical signals. The antenna elements may be arranged into one or more antenna panels. The antenna 1426 may have antenna panels that are omnidirectional, directional, or a combination thereof to enable beamforming and multiple input, multiple output communications. The antenna 1426 may include microstrip antennas, printed antennas fabricated on the surface of one or more printed circuit boards, patch antennas, or phased array antennas. The antenna 1426 may have one or more panels designed for specific frequency bands, including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within or connected to the UE 1400. For example, driver circuitry 1422 may include a display driver to control and allow access to a display device, a touchscreen driver to control and allow access to a touchscreen interface, sensor drivers to obtain sensor readings of sensors 1420, and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

A battery 1428 may power the UE 1400, although in some examples, the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

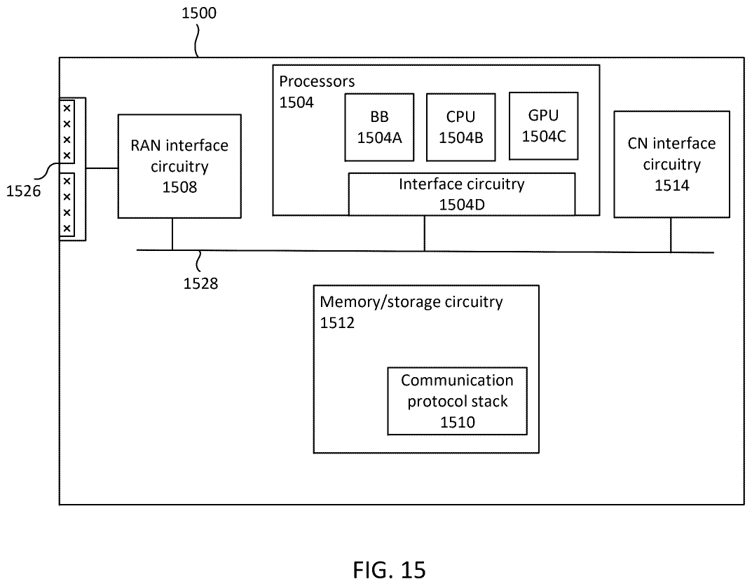

FIG. 15 illustrates a network device 1500 in accordance with some embodiments. The network device 1500 may be similar to and substantially interchangeable with base station 108.

The network device 1500 may include processors 1504, RF interface circuitry 1508 (if implemented as a base station), core network (CN) interface circuitry 1514, memory/storage circuitry 1512, and antenna structure 1526.

The components of the network device 1500 may be coupled with various other components over one or more interconnects 1528.

The processors 1504, RF interface circuitry 1508, memory/storage circuitry 1512 (including communication protocol stack 1510), antenna structure 1526, and interconnects 1528 may be similar to like-named elements shown and described with respect to FIG. 14.

The processors 1504 may include processor circuitry such as, for example, baseband processor circuitry (BB) 1504A, central processor unit circuitry (CPU) 1504B, and graphics processor unit circuitry (GPU) 1504C. The processors 1504 may include any type of circuitry or processor circuitry that executes or otherwise operates computer-executable instructions, such as program code, software modules, or functional processes from memory/storage circuitry 1512 to cause the UE 1400 to perform operations as described herein. The processors 1504 may also include interface circuitry 1504D to communicatively couple the processor circuitry with one or more other components of the network device 1500.

The CN interface circuitry 1514 may provide connectivity to a core network, for example, a 5th Generation Core network (5GC) using a 5GC-compatible network interface protocol such as carrier Ethernet protocols or some other suitable protocol. Network connectivity may be provided to/from the network device 1500 via a fiber optic or wireless backhaul. The CN interface circuitry 1514 may include one or more dedicated processors or FPGAs to communicate using one or more of the aforementioned protocols. In some implementations, the CN interface circuitry 1514 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: generating a message to be transmitted to a network node, the message to request an artificial intelligence (AI)-machine learning (ML) model for selecting a connected mode discontinuous reception (C-DRX) profile from one or more C-DRX profiles or a control profile; and processing a control signaling including an indication of the AI-ML model.

Example 2 includes the method of example 1 or some other examples herein, wherein the control profile is a channel state information (CSI) scheduling, a buffer status report scheduling, a downlink scheduling, a traffic prediction, a quality of experience (QoE) prediction, or a buffer state prediction.

Example 3 includes the method of examples 1 or 2 or some other examples herein, wherein the message includes an indication requesting the one or more C-DRX profiles, and the control signaling includes the one or more C-DRX profiles.

Example 4 includes the method of any of examples 1-3 or some other examples herein, the method further including: selecting the C-DRX profile from the one or more C-DRX profiles based on the AI-ML model.

Example 5 includes the method of any of examples 1˜4 or some other examples herein, wherein the message is a first message, and the method further includes: generating a second message requesting a reconfiguration based on the C-DRX profile.

Example 6 includes the method of any of examples 1-5 or some other examples herein, further including: processing a response including a reconfiguration command based on the C-DRX profile.

Example 7 includes the method of any of examples 1-6 or some other examples herein, wherein the control signaling is a radio resource control (RRC) configuration or reconfiguration signaling, a medium access control (MAC) control element (CE), a hypertext transfer protocol (HTTP) message, or a downlink control information (DCI).

Example 8 includes the method of any of examples 1-7 or some other examples herein, wherein the message is an uplink control information (UCI), or a medium access control (MAC) control element (CE).

Example 9 includes the method of any of examples 1-8 or some other examples herein, wherein the AI-ML model is a first AI-ML model and the message includes a second AI-ML model.

Example 10 includes the method of any of examples 1-9 or some other examples herein, wherein the message includes an indication of an application and the AI-ML model is associated with the application.

Example 11 includes the method of any of examples 1-10 or some other examples herein, wherein the indication of the application is an application category.

Example 12 includes the method of any of examples 1-11 or some other examples herein, wherein the message includes C-DRX assistance information and AI-ML model information.

Example 13 includes the method of any of examples 1-12 or some other examples herein, wherein the network node is a base station, an application server, or a network function (NF).

Example 14 includes the method of any of examples 1-13 or some other examples herein, further including: generating a capability message including an AI-ML C-DRX profile selection capability.

Example 15 includes the method of any of examples 1-14 or some other examples herein, further including: determining, based on the AI-ML model, whether to perform a wake up procedure in an ON duration associated with the C-DRX profile.

Example 16 includes the method of any of examples 1-15 or some other examples herein, wherein the message is a first message, the AI-ML model is a first AI-ML model, and the method further includes: determining that a number of undetected scheduling opportunities is larger than a threshold; and generating a second message requesting a second AI-ML model.

Example 17 includes the method of any of examples 1-16 or some other examples herein, further including: performing a data collection.

Example 18 includes the method of any of examples 1-17 or some other examples herein, wherein the data collection is a cross-layer data collection.

Example 19 includes the method of any of examples 1-18 or some other examples herein, wherein the data includes time-associate data, known performance metric (KPI), trace log, or event data.

Example 20 includes the method of any of examples 1-19 or some other examples herein, wherein the AI-ML model is trained based on the data.

Example 21 includes a method including: processing a message received from a user equipment (UE), the message requesting an artificial intelligence (AI)-machine learning (ML) model for selecting a connected mode discontinuous reception (C-DRX) profile from one or more C-DRX profiles or a control profile; and generating a control signaling to be transmitted to the UE, the control signaling to include the AI-ML model.

Example 22 includes the method of example 21 or some other examples herein, wherein the control profile is a channel state information (CSI) scheduling, a buffer status report scheduling, a downlink scheduling, a traffic prediction, a quality of experience (QoE) prediction, or a buffer state prediction.

Example 23 includes the method of examples 21 or 22 or some other examples herein, further including: wherein the message includes an indication requesting the one or more C-DRX profiles, and the control signaling includes the one or more C-DRX profiles.

Example 24 includes the method of any of examples 21-23 or some other examples herein, wherein the message is a first message, and the method further includes: processing a second message including an indication of the C-DRX profile and an indication requesting a reconfiguration.

Example 25 includes the method of any of examples 21-24 or some other examples herein, further including: generating a response including a reconfiguration command based on the C-DRX profile.

Example 26 includes the method of any of examples 21-25 or some other examples herein, wherein the control signaling is a radio resource control (RRC) configuration or reconfiguration signaling, a medium access control (MAC) control element (CE), a hypertext transfer protocol (HTTP) message, or a downlink control information (DCI).

Example 27 includes the method of any of examples 21-26 or some other examples herein, wherein the message is an uplink control information (UCI), or a medium access control (MAC) control element (CE).

Example 28 includes the method of any of examples 21-27 or some other examples herein, wherein the AI-ML model is a first AI-ML model and the message includes a second AI-ML model.

Example 29 includes the method of any of examples 21-28 or some other examples herein, wherein the message includes an indication of an application and the AI-ML model is associated with the application.

Example 30 includes the method of any of examples 21-29 or some other examples herein, wherein the indication of the application is an application category

Example 31 includes the method of any of examples 21-30 or some other examples herein, wherein the message includes C-DRX assistance information and AI-ML model information.

Example 32 includes the method of any of examples 21-31 or some other examples herein, further including: processing a capability message including an AI-ML C-DRX profile selection capability.

Example 33 includes the method of any of examples 21-32 or some other examples herein, wherein the control signaling is a first control signaling, the AI-ML model is a first AI-ML model, and the method further includes: determining that a number of undetected grants or DL data is larger than a threshold; and generating a second control signaling reconfiguring the UE with a default C-DRX configuration.

Example 33 includes the method of any of examples 21-32 or some other examples herein, further including: performing a data collection.

Example 34 includes the method of any of examples 21-33 or some other examples herein, wherein the data collection is a cross-layer data collection.

Example 35 includes the method of any of examples 21-34 or some other examples herein, wherein the data includes time-associate data, known performance metric (KPI), trace log, or event data.

Example 36 includes the method of any of examples 21-35 or some other examples herein, wherein the AI-ML model is trained based on the data.

Example 38 includes a method including: processing a control signaling including an indication of an artificial intelligence (AI)-machine learning (ML) model for selecting a connected mode discontinuous reception (C-DRX) profile from one or more C-DRX profiles; and selecting the C-DRX profile from the one or more C-DRX profiles based on the AI-ML model.

Example 39 includes the method of example 38 or some other examples herein, further including: generating a message requesting a reconfiguration based on the C-DRX profile.

Example 40 includes a method including: generating a control signaling including an indication of an artificial intelligence (AI)-machine learning (ML) model for selecting a connected mode discontinuous reception (C-DRX) profile from one or more C-DRX profiles; and processing a message received from a user equipment, the message includes an indication of the C-DRX profile from the one or more C-DRX profiles.

Example 41 includes the method of example 40 or some other examples herein, further including: generating a response including a reconfiguration command based on the C-DRX profile.

Another example may include an apparatus comprising means to perform one or more elements of a method described in or related to any of examples 1-40, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Another example may include an apparatus comprising logic, modules, or circuitry to perform one or more elements of a method described in or related to any of examples 1-40, or any other method or process described herein.

Another example may include a method, technique, or process as described in or related to any of examples 1-40, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-40, or portions thereof.

Another example may include a signal as described in or related to any of examples 1-40, or portions or parts thereof.

Another example may include a datagram, information element, packet, frame, segment, PDU, or message as described in or related to any of examples 1-40, or portions or parts thereof, or otherwise described in the present disclosure.

Another example may include a signal encoded with data as described in or related to any of examples 1-40, or portions or parts thereof, or otherwise described in the present disclosure.

Another example may include a signal encoded with a datagram, IE, packet, frame, segment, PDU, or message as described in or related to any of examples 1-40, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-40, or portions thereof.

Another example may include a computer program comprising instructions, wherein execution of the program by a processing element is to cause the processing element to carry out the method, techniques, or process as described in or related to any of examples 1-40, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
generating a message to be transmitted to a network node, the message to request an artificial intelligence (AI)-machine learning (ML) model for selecting a connected mode discontinuous reception (C-DRX) profile from one or more C-DRX profiles or a network control; and
processing control signaling including an indication of the AI-ML model.

2. The method of claim 1, wherein:
the network control is a channel state information (CSI) scheduling, a buffer status report scheduling, a downlink scheduling, a traffic prediction, a quality of experience (QoE) prediction, or a buffer state prediction; and
the network node is a base station, an application server, or a network function (NF).

3. The method of claim 1, wherein the message includes:
an indication requesting the one or more C-DRX profiles, and the control signaling includes the one or more C-DRX profiles;
an indication of an application, the AI-ML model is associated with the application, and the indication of the application is an application category; or
C-DRX profile selection assistance information and AI-ML model information.

4. The method of claim 1, further comprising:
selecting, based on the indication of the AI-ML model, the C-DRX profile from the one or more C-DRX profiles.

5. The method of claim 4, wherein the message is a first message, and the method further comprises:
generating a second message requesting a reconfiguration based on the C-DRX profile; and
processing a response including a reconfiguration command based on the C-DRX profile.

6. The method of claim 1, further comprising:
generating a capability message including an AI-ML C-DRX profile selection capability.

7. The method of claim 1, further comprising:
determining, based on an indication of the AI-ML model, whether to perform a wake up procedure in an ON duration associated with the C-DRX profile.

8. The method of claim 1, wherein the message is a first message, the AI-ML model is a first AI-ML model, and the method further comprises:
determining that a number of undetected scheduling opportunities is larger than a threshold; and
generating a second message requesting a second AI-ML model.

9. The method of claim 1, further comprising:
collecting cross-layer data that includes time-associate data, known performance metric (KPI), trace log, or event data, wherein the AI-ML model is trained based on the cross-layer data.

10. The method of claim 1, wherein the control signaling is a radio resource control (RRC) configuration or reconfiguration signaling, a medium access control (MAC) control element (CE), a hypertext transfer protocol (HTTP) message, or a downlink control information (DCI).

11. An apparatus comprising:
processing circuitry to:
process a message received from a user equipment (UE), the message requesting an artificial intelligence (AI)-machine learning (ML) model for selecting a connected mode discontinuous reception (C-DRX) profile from one or more C-DRX profiles or a network control; and
generate control signaling to be transmitted to the UE, the control signaling to include an indication of the AI-ML model; and
interface circuitry coupled with the processing circuitry to enable communication.

12. The apparatus of claim 11, wherein the network control is a channel state information (CSI) scheduling, a buffer status report scheduling, a downlink scheduling, a traffic prediction, a quality of experience (QoE) prediction, or a buffer state prediction.

13. The apparatus of claim 11, wherein the message includes an indication requesting the one or more C-DRX profiles, and the control signaling includes the one or more C-DRX profiles.

14. The apparatus of claim 11, wherein
the control signaling is a radio resource control (RRC) configuration or reconfiguration signaling, a medium access control (MAC) control element (CE), a hypertext transfer protocol (HTTP) message, or a downlink control information (DCI);
the message is an uplink control information (UCI), or a medium access control (MAC) control element (CE); and
the message includes C-DRX assistance information and AI-ML model information.

15. The apparatus of claim 11, wherein the message is a first message, and the processing circuitry is further to:
process a second message including an indication of the C-DRX profile and an indication requesting a reconfiguration; and
generate a response including a reconfiguration command based on the C-DRX profile.

16. The apparatus of claim 11, wherein the processing circuitry is further to:
process a capability message including an AI-ML C-DRX profile selection capability.

17. The apparatus of claim 11, wherein the control signaling is first control signaling, the AI-ML model is a first AI-ML model, and the processing circuitry is further to:
determine that a number of undetected grants or DL data is larger than a threshold; and
generate second control signaling to reconfigure the UE with a default C-DRX configuration.

18. The apparatus of claim 11, wherein the processing circuitry is further to:
collect cross-layer data, wherein the cross-layer data includes time-associate data, known performance metric (KPI), trace log, or event data, wherein the AI-ML model is trained based on the cross-layer data.

19. One or more non-transitory computer-readable media having instructions that, when executed, cause processing circuitry to:
generate control signaling including an indication of an artificial intelligence (AI)-machine learning (ML) model for selecting a connected mode discontinuous reception (C-DRX) profile from one or more C-DRX profiles; and
process a message received from a user equipment, the message includes an indication of the C-DRX profile from the one or more C-DRX profiles.

20. The one or more non-transitory computer-readable media of claim 19, wherein the instructions, when executed, further cause the processing circuitry to:
generate a response including a reconfiguration command based on the C-DRX profile.
